(19) United States
(12) Patent Application Publication
(10) Pub. No.: US 2023/0294308 A1
(43) Pub. Date: Sep. 21, 2023

(54) WAIST STRUCTURE OF ROBOT, AND ROBOT

(71) Applicant: Tencent Technology (Shenzhen) Company Limited, Shenzhen (CN)

(72) Inventors: Dongsheng Zhang, Shenzhen (CN); Fusheng Liu, Shenzhen (CN); Qiwei Xu, Shenzhen (CN)

(21) Appl. No.: 18/202,222

(22) Filed: May 25, 2023

Related U.S. Application Data
(63) Continuation of application No. PCT/CN2022/125435, filed on Oct. 14, 2022.

(30) Foreign Application Priority Data
Jan. 4, 2022 (CN) 202210003032.1

(51) Int. Cl. B25J 17/02; B25J 9/12; B25J 9/10; B62D 57/032

(52) U.S. Cl. CPC B25J 17/0258; B25J 9/104; B25J 9/108; B25J 9/12; B62D 57/032

(57) ABSTRACT

Disclosed are a waist structure of a robot. The waist structure includes: a fixed platform, a connector, a movable platform, a load-carrying bearing and two motors arranged on the fixed platform, and two drive assemblies. The connector includes first and second ends facing away from each other; the first end is provided with a yaw shaft connected to an inner ring of the load-carrying bearing; and the second end is provided with a pitch shaft rotatably connected to the movable platform. Each drive assembly corresponds to one motor, and the drive assemblies are connected to the movable platform and the corresponding motors. The motors can actuate the drive assemblies to drive the movable platform to rotate relative to the connector in an axial direction of the pitch shaft and the connector to rotate relative to the fixed platform in an axial direction of the yaw shaft.

### CROSS-REFERENCE TO RELATED APPLICATIONS

This application is a continuation application of PCT Patent Application No. PCT/CN2022/125435, entitled “WAIST STRUCTURE OF ROBOT, AND ROBOT” filed on Oct. 14, 2022, which claims priority to Chinese Patent Application No. 202210003032.1, entitled “WAIST STRUCTURE OF ROBOT, AND ROBOT” filed with the China National Intellectual Property Administration on Jan. 04, 2022, all of which is incorporated herein by reference in its entirety.

### FIELD OF THE TECHNOLOGY

This application relates to the technical field of robots, specifically to a waist structure of a robot, and a robot.

### BACKGROUND OF THE DISCLOSURE

Some bio-robots can simulate actions and postures of human or animals. The waist of a bio-robot serves as an important connecting structure, which plays a role of supporting the body and upper limbs, enlarging an operating space, and making the entire robot more flexible in motion. To achieve agile operations of the upper part of the body, the waist needs to have a sufficient degree of freedom and high load-bearing capacity, as well as to be able to quickly perform actions such as bending down, bending backward, and side swaying.

The waist of the bio-robot is mostly achieved in a series configuration. Generally, a motor and a reducer need to be integrated into a complete set of module to form an actuator. The module is relatively heavy, usually has poor load-bearing capacity and transmission accuracy, and has a limited range of motion. Therefore, how to design a waist structure reasonably is crucial for system construction of a bio-robot.

### SUMMARY

Embodiments of this application provide a waist structure of a robot and a robot, which can achieve large-range and high-dexterity motions of a robot in a pitch angle direction and a yaw angle direction and make the robot have relatively high load-bearing capacity and stability.

The embodiments of this application provides a waist structure of a robot. The waist structure includes: a fixed platform, a load-carrying bearing, a connector, a movable platform, two motors, and two drive assemblies. The load-carrying bearing is arranged on the fixed platform. The connector includes a first end and a second end facing away from each other; the first end is provided with a yaw shaft; the yaw shaft is connected to the load-carrying bearing; and the second end is provided with a pitch shaft. The movable platform is rotatably connected to the pitch shaft. One or more motors are arranged on the fixed platform and one or more drive assemblies are connected to the movable platform and the corresponding motors. The motors are configured to actuate the drive assemblies to drive the movable platform to, independently, rotate relative to the connector in an axial direction of the pitch shaft and rotate relative to the fixed platform in an axial direction of the yaw shaft.

The embodiments of this application provide a robot. The robot includes the waist structure according to any one of the above implementations, a body structure, and a lower limb structure. The body structure is connected to the movable platform. The lower limb structure is connected to the fixed platform.

The waist structure of the robot provided by the embodiments of this application can achieve large-range and high-dexterity motions of a robot in a pitch angle direction and a yaw angle direction and make the robot have relatively high load-bearing capacity and stability. The robot provided by the embodiments of this application can achieve motions of an upper limb structure relative to the lower limb structure in two degrees of freedom, namely, in the pitch angle direction and the yaw angle direction, so that the robot has relatively high load-carrying capacity and relatively good drive capacity.

### BRIEF DESCRIPTION OF THE DRAWINGS

In order to illustrate the technical solutions in the embodiments of this application more clearly, the following briefly introduces the accompanying drawings required in the description of the embodiments. Obviously, the accompanying drawings described below are only some embodiments of this application. Those of ordinary skill in the art can also obtain other drawings according to the drawings without any creative work.

FIG. 1 is an axis view of a waist structure according to an embodiment of this application.

FIG. 2 is a schematic structural diagram of a robot according to an embodiment of this application.

FIG. 3 is a schematic structural diagram of a waist structure according to an embodiment of this application.

FIG. 4 is a sectional view of a waist structure according to an embodiment of this application.

FIG. 5 is another axis view of a waist structure according to an embodiment of this application.

FIG. 6 is a front view of a drive assembly according to an embodiment of this application.

FIG. 7 is an exploded diagram of a waist structure according to an embodiment of this application.

FIG. 8 is still another axis view of a waist structure according to an embodiment of this application.

FIG. 9 is a schematic diagram of an action principle of gravity compensation of a waist structure according to an embodiment of this application.

FIG. 10 is another schematic diagram of an action principle of gravity compensation of a waist structure according to an embodiment of this application.

### DESCRIPTION OF EMBODIMENTS

The technical schemes in the embodiments of this application will be clearly and completely described below with reference to the drawings in the embodiments of this application, and it is obvious that the described embodiments are only a part of the embodiments of this application, but not all of them. All other embodiments obtained by a person skilled in the art based on the embodiments of this application without creative efforts shall fall within the protection scope of this application.

In the description of this application, it should be understood that orientation or position relationships indicated by the terms such as “center”, “longitudinal”, “transverse”, “length”, “width”, “thickness”, “on”, “under”, “front”, “rear”, “left”, “right”, “vertical”, “horizontal”, “top”, “bottom”, “inside”, “outside”, “clockwise”, “anticlockwise”, and the like are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as limiting of this application. In addition, the terms “first” and “second” are only for the purpose of description, and may not be understood as indicating or implying the relative importance or implicitly indicating the number of technical features indicated. Thus, features defined by “first” and “second” may expressly or implicitly include one or more of that feature. In the description of the present invention, “plurality” means two or more, unless otherwise expressly and specifically defined.

In the description of this application, it should be noted that unless otherwise explicitly specified or defined, the terms such as “mount”, “connect”, and “couple” should be understood in a broad sense. For example, the connection may be a fixed connection, a detachable connection, an integral connection, a mechanical connection, an electrical connection, or mutual communication. Or, the connection may be a direct connection, an indirect connection through an intermediate medium, internal communication between two components, or an interaction relationship between two components. A person of ordinary skill in the art may understand the specific meanings of the foregoing terms in this application according to specific situations.

In this application, unless otherwise explicitly stipulated and restricted, that a first feature is “on” or “below” a second feature may include that the first and second features are in direct contact, or may include that the first and second features are not in direct contact but in contact by using other features therebetween. In addition, that the first feature is “on”, “above”, or “over” the second feature includes that the first feature is right above and on the inclined top of the second feature or merely indicates that a level of the first feature is higher than that of the second feature. That the first feature is “below”, “under”, or “beneath” the second feature includes that the first feature is right below and at the inclined bottom of the second feature or merely indicates that a level of the first feature is lower than that of the second feature.

Many different implementations or examples are provided in the following disclosure to implement different structures of this application. To simplify the disclosure of this application, components and settings in particular examples are described below. Of course, they are merely examples and are not intended to limit this application. In addition, in this application, reference numerals and/or reference letters may be repeated in different examples. The repetition is for the purposes of simplification and clearness, and is not intended to indicate relationships between the various implementations and/or settings discussed herein. Moreover, this application provides examples of various particular processes and materials, but a person of ordinary skill in the art may be aware of application of other processes and/or use of other materials.

The embodiments of this application can be applied to various application scenarios such as artificial intelligence, a robot technology, mechanical and electrical integration, and the like.

First, some nouns or terms appearing in a process of describing the embodiments of this application are suitable for the following explanations:

Artificial Intelligence (AI) involves a theory, a method, a technology, and an application system that use a digital computer or a machine controlled by the digital computer to simulate, extend, and expand human intelligence, sense an environment, obtain knowledge, and use the knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

A robot is a machine that can perform tasks such as work or movement through programming and automatic control. Robots have basic features such as perception, decision-making, and execution, which can assist or even replace human in completing dangerous, burdensome, and complex work, to improve the working efficiency and quality, serve human life, and expand or extend the range of human activities and abilities.

The mechanical and electrical integration technology is a comprehensive high-tech that combines a microelectronic technology, a computer technology, an information technology, and a mechanical technology. It is an organic combination of the mechanical technology and the microelectronic technology.

A degree of freedom refers to the number of independent motion parameters that needs to be given for determining a motion of a mechanism according to a mechanical principle. In a definition of a degree of freedom, uniqueness, necessity, and independence are three key words. Unique determination means that after these variables are given, the robot has a unique configuration. Necessity is a minimal concept, which means a minimum number of variables that can determine a status of the robot. Independence means that these variables can change independently.

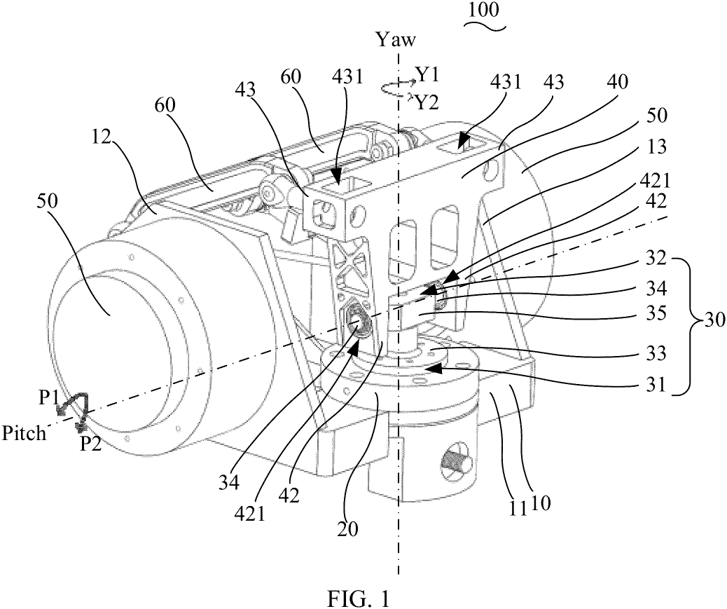

Specifically, referring to FIG. 1 to FIG. 10, the embodiments of this application provide a waist structure 100 of a robot 1000. The waist structure 100 includes a fixed platform 10, a load-carrying bearing 20, a connector 30, a movable platform 40, two motors 50, and two drive assemblies 60. The load-carrying bearing 20 is arranged on the fixed platform 10. The connector 30 includes a first end 31 and a second end 32 facing away from each other. The first end 31 is provided with a yaw shaft 33. The yaw shaft 33 is connected to an inner ring 21 of the load-carrying bearing 20. The second end 32 is provided with a pitch shaft 34. The movable platform 40 and the pitch shaft 34 are rotatably connected. The two motors 50 are arranged on the fixed platform 10. Each drive assembly 60 corresponds to one motor 50, and the drive assemblies 60 are connected to the movable platform 40 and the corresponding motors 50. The motors 50 can actuate the drive assemblies 60 to drive the movable platform 40 to rotate relative to the connector 30 in an axial direction of the pitch shaft 34, and can actuate the corresponding drive assemblies 60 to drive the movable platform 40 and the connector 30 to rotate relative to the fixed platform 10 in an axial direction of the yaw shaft 33.

The “fixed platform 10” and the “movable platform 40” are meant to indicate that the two platforms can move relatively, rather than limiting that the fixed platform 10 needs to be in a stationary state and that the movable platform 40 needs to be in a moving state. Therefore, the fixed platform 10 and the movable platform 40 here may be referred to as a “first platform” and a “second platform”, respectively.

Referring to FIG. 1, in an inertial coordinate system (inertial system) corresponding to the waist structure 100, the movable platform 40 rotates relative to the connector 30 in the axial direction of the pitch shaft 34. Equivalently, the movable platform 40 rotates relative to the fixed platform 10 in a pitch angle direction (P1/P2 direction) of a posture angle. The movable platform 40 rotates relative to the fixed platform 10 in the axial direction of the yaw shaft 33. Equivalently, the movable platform 40 rotates relative to the fixed platform 10 in a yaw angle direction (Y1/Y2 direction) of the posture angle. In this way, the waist structure 100 has two degrees of freedom, and can achieve large-range and high-dexterity motions in the pitch angle (P1/P2) direction and the yaw angle (Y1/Y2) direction.

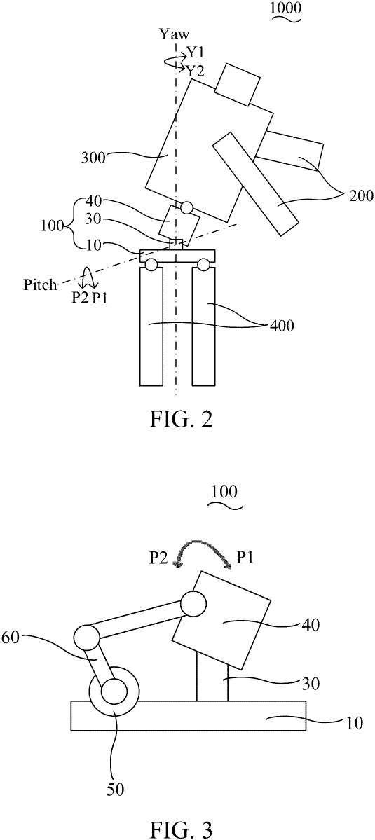

Referring to FIG. 2, FIG. 2 is a humanoid robot 1000 using a waist structure 100. The humanoid robot 1000 includes an upper limb structure 200, a body structure 300, a waist structure 100, and a lower limb structure 400. A fixed platform 10 of the waist structure 100 is connected to the lower limb structure 400, and a movable platform 40 is connected to the body structure 300. The waist structure 100 can connect the body structure 300 with the lower limb structure 400. In a case that the movable platform 40 rotates relative to a connector 30 in an axial direction of a pitch shaft 34, the movable platform 40 rotates relative to the fixed platform 10 in a pitch direction (P1/P2 direction), so that the movable platform 40 can drive the body structure 300 to perform actions of “bending down”, “bending backward”, and the like relative to the lower limb structure 400. In a case that the movable platform 40 and the connector 30 rotate relative to the fixed platform 10 in an axial direction of a yaw shaft 33, the movable platform 40 rotates relative to the fixed platform 10 in a yaw direction (Y1/ Y2 direction), so that the movable platform 40 can drive the body structure 300 to perform actions of “twisting the waist”, “side swaying”, and the like relative to the lower limb structure 400. In this way, the waist structure 100 can achieve that the body structure 300 of the humanoid robot has two degrees of freedom in motion relative to the lower limb structure 400, and meet a demand of the humanoid robot 1000 for large-range and high-dexterity motions, so that the humanoid robot 1000 can make more postures.

The waist structure 100 of this embodiment of this application is not limited to being applied to the humanoid robot 1000. Some bio-robots, for example, a quadruped robot, a hexapod robot, an eight-legged robot, and a snake-type robot, which have the body structure 300 and the lower limb structure 400 can also use the waist structure 100, so that the body structure 300 has two degrees of freedom in motion relative to the lower limb structure 400, to improve the motion range and motion dexterity of the bio-robot 1000.

Referring to FIG. 1, two motors 50 serving as power output apparatuses are arranged in the waist structure 100, and each motor 50 corresponds to one drive assembly 60. The drive assemblies 60 transmit power output by the motors 50 to the movable platform 40, to drive the movable platform 40 to rotate relative to the fixed platform 10. Each motor 50 independently actuates the corresponding drive assembly 60 to move, that is, motions of the two drive assemblies 60 of the waist structure 100 are independent of each other. The drive assemblies 60 are connected to the movable platform 40 and the motors 50 arranged in the fixed platform 10. Equivalently, the drive assemblies 60 are connected to the movable platform 40 and the fixed platform 10. In this way, the fixed platform 10 and the movable platform 40 of the waist structure 100 are connected through the two drive assemblies 60 that move independently. Furthermore, the waist structure 100 has two degrees of freedom, so that the waist structure 100 is in a parallel form. Compared with a serial form, in the parallel waist structure 100 of this embodiment of this application, the motor 50 has a relatively small rotational inertia and high rotation accuracy, so that a requirement for a torque of the motor 50 is relatively low. It is not necessary to arrange a reducer to ensure the drive accuracy, so that the number of essential parts of the waist structure 100 can be reduced, the waist structure 100 is more compact, and the weight of the waist structure 100 is reduced. Furthermore, the rigidity of the parallel form is greater than that of the serial form, so that the waist structure 100 has relatively high carrying capacity.

In some embodiments, referring to FIG. 3, FIG. 3 is a simplified schematic diagram of the fixed platform 10, the movable platform 40, the connector 30, the motors 50, and the drive assemblies 60 of the waist structure 100. In the perspective of FIG. 3, the motors 50 can rotate clockwise, to actuate the drive assemblies 60 to drive the movable platform 40 to rotate relative to the fixed platform 10 clockwise (in the P1 direction), performing an action of “bending down”. Similarly, the motors 50 can rotate anticlockwise (in the P2 direction), to actuate the drive assemblies 60 to drive the movable platform 40 to rotate relative to the fixed platform 10 anticlockwise, performing an action of “bending backward”.

In some embodiments, with reference to FIG. 1, a rotation direction of a revolute pair formed by the drive assemblies 60 and the corresponding motors 50 is in the pitch angle (P1/P2) direction, so that the rotation, in the pitch angle direction, of the movable platform 40 driven by the drive assemblies 60 has a relatively large rotation range, which can achieve that the movable platform 40 rotates relative to the fixed platform 10 in a large angle in the pitch angle (P1/P2) direction, that is, the movable platform 40 can perform large-angle actions of “bending down” and “bending backward”.

In some embodiments, referring to FIG. 1 and FIG. 3, in the waist structure 100 provided in this embodiment of this application, the drive assemblies 60 are connected to the corresponding motors 50 in a manner of the revolute pair, and the drive assemblies 60 are connected to the movable platform at a position in front of or behind the movable platform. In this way, the drive assemblies do not need to be arranged between the movable platform 40 and the fixed platform 10, so that the movable platform 40 and the fixed platform 10 can be arranged more compactly, which is conductive to achieving a small-sized design of the waist structure 100.

In summary, in the waist structure 100 of this embodiment of this application, the motors 50 can actuate the drive assemblies 60 to do a circumferential motion, to drive the movable platform 40 to do a large-range and high-dexterity motion relative to the fixed platform 10 in the pitch angle (P1/P2) direction and the yaw angle (Y1/Y2) direction, so that the waist structure 100 is constituted into the parallel form, has the two degrees of freedom, and has the advantages of high carrying capacity, high dynamic response capacity, high motion accuracy, large motion range, compact structure, and the like.

The following describes the waist structure 100 according to the embodiments of this application with reference to the accompanying drawings.

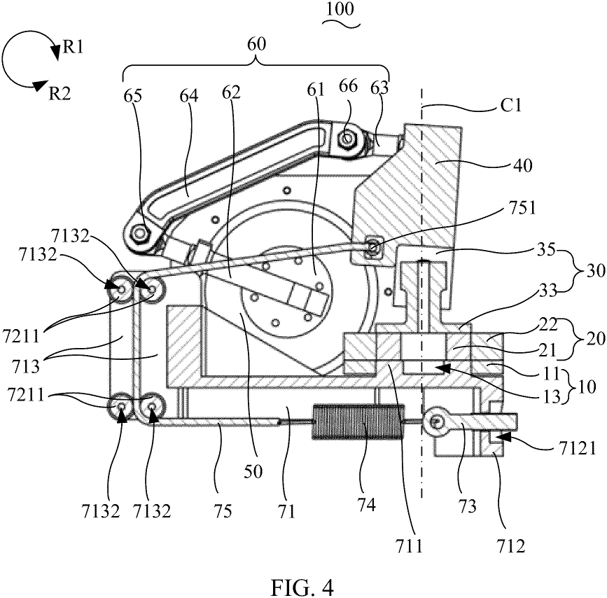

Referring to FIG. 1 and FIG. 4, the load-carrying bearing 20 is arranged on the fixed platform 10. Specifically, an outer ring 22 of the load-carrying bearing 20 is connected to the fixed platform 10, and the inner ring 21 of the load-carrying bearing 20 can rotate relative to the outer ring 22, that is, can rotate relative to the fixed platform 10. The yaw shaft 33 of the first end 31 of the connector 30 is connected to the inner ring 21 of the load-carrying bearing 20. The pitch shaft 34 of the second end 32 of the connector 30 is rotatably connected to the movable platform 40, to connect the movable platform 40 to the fixed platform 10. In a case that the movable platform 40 is actuated to rotate in the yaw angle (Y1/Y2) direction, the connector 30 and the inner ring 21 of the load-carrying bearing 20 rotate in the yaw angle (Y1/Y2) direction together, that is, the movable platform 40, the connector 30, and the inner ring 21 of the load-carrying bearing 20 rotate relative to the fixed platform 10 in the axial direction of the yaw shaft. In a case that the movable platform 40 is actuated to rotate in the pitch angle (P1/P2) direction, the movable platform 40 rotates relative to the connector 30 in the axial direction of the pitch shaft 34, to achieve that the movable platform 40 rotates relative to the connector 30 in the axial direction of the pitch shaft 34.

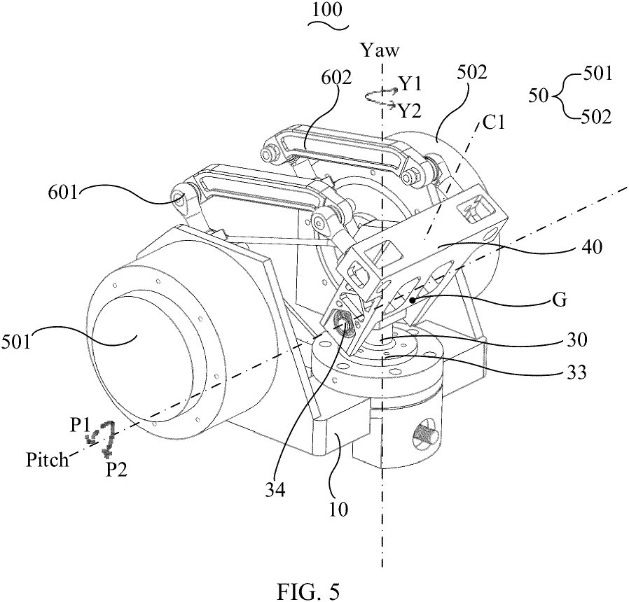

In some embodiments, with reference to FIG. 5, the two motors 50 respectively independently actuate the corresponding drive assemblies 60 to move. In a case that the two motors 50 synchronously rotate in the same direction, the two motors 50 actuate the corresponding drive assemblies 60 to drive the movable platform 40 to rotate relative to the connector 30 in the axial direction of the pitch shaft 34. In a case that rotation directions of the two motors 50 are different, the two motors 50 actuate the corresponding drive assemblies 60 to drive the movable platform 40 and the connector 30 to rotate relative to the fixed platform 10 in the axial direction of the yaw shaft 33.

For example, referring to FIG. 4 and FIG. 5, it is assumed that the two motors 50 are separately a motor 501 and a motor 502, and that the two drive assemblies 60 are separately a drive assembly 601 and a drive assembly 602. It is assumed that a clockwise direction R1 shown in FIG. 5 is a forward rotation direction of the motor 501 and the motor 502, and an anticlockwise direction R2 is a backward rotation direction of the motor 501 and the motor 502.

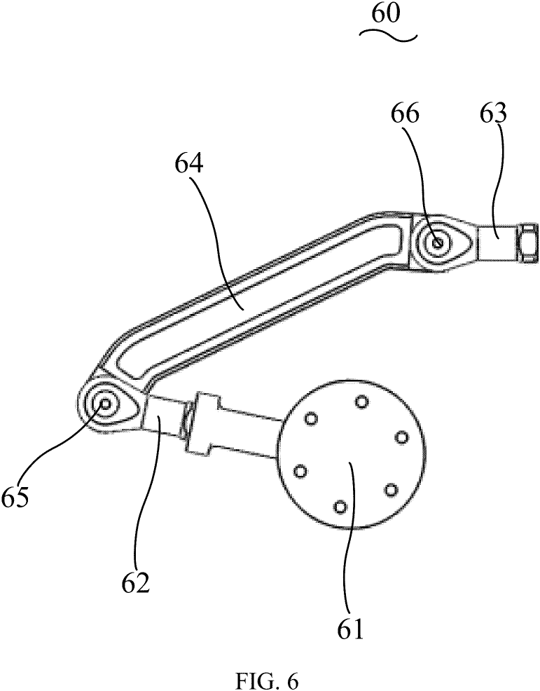

In some embodiments, referring to FIG. 4 and FIG. 5, positions of the two drive assemblies 60 connected to the movable platform 40 are located above a center-of-gravity position G of the movable platform 40. Referring to FIG. 6, when the motor 501 and the motor 502 synchronously rotate at the same speed in the forward direction, the drive assembly 601 and the drive assembly 602 synchronously push the movable platform 40 to rotate in the pitch angle (P1/P2) P1 direction to perform an action of “bending down”. Referring to FIG. 5, when the motor 501 and the motor 502 synchronously rotate at the same speed in the backward direction, the drive assembly 601 and the drive assembly 602 synchronously pull the movable platform 40 to rotate in the pitch angle (P1/P2) P2 direction to perform an action of “bending backward”. Referring to FIG. 6, when speeds of the motor 501 and the motor 502 are the same, that the motor 501 rotates in the forward direction, and that the motor 502 rotates in the backward direction, the drive assembly 601 pushes the movable platform 40, and the drive assembly 602 pulls the movable platform 40, so that the movable platform 40 rotates in the yaw angle (Y1/Y2) Y1 direction. In a case that speeds of the motor 501 and the motor 502 are the same, that the motor 501 rotates in the backward direction, and that the motor 502 rotates in the forward direction, the drive assembly 601 pulls the movable platform 40, and the drive assembly 602 pushes the movable platform 40, so that the movable platform 40 rotates in the yaw angle (Y1/Y2) Y2 direction.

In some embodiments, referring to FIG. 4 and FIG. 5, when rotation directions of the two motors 50 are different and speeds of the two motors 50 are different, the two motors 50 actuate the corresponding drive assemblies 60 to drive the movable platform 40 to rotate relative to the connector 30 in the axial direction of the pitch shaft 34, and the two motors 50 actuate the corresponding drive assemblies 60 to drive the movable platform 40 and the connector 30 to rotate relative to the fixed platform 10 in the axial direction of the yaw shaft 33. Positions of the two drive assemblies 60 connected to the movable platform 40 are respectively located on left and right sides of a center axis C1 of the movable platform 40. In a case that speeds of the motor 501 and the motor 502 are different, the drive assembly 601 and the drive assembly 602 can drive the movable platform 40 to rotate in the pitch angle (P1/P2) direction and the yaw angle (Y1/Y2) direction. For example, referring to FIG. 5, when the motor 501 rotates in the forward direction and that the motor 502 does not rotate, the drive assembly 601 pushes the movable platform 40 to rotate in the pitch angle (P1/P2) P1 direction. In addition, since only the drive assembly 601 pushes the movable platform 40, the left side of the center axis of the movable platform 40 is stressed, which can drive the movable platform 40 to rotate in the yaw angle (Y1/Y2) Y1 direction.

In some embodiments, referring to FIG. 4 and FIG. 5, when rotation directions of the two motors 50 are different and speeds of the two motors 50 are different, the two motors 50 actuate the corresponding drive assemblies 60 to drive the movable platform 40 to rotate relative to the connector 30 in the axial direction of the pitch shaft 34, and the two motors 50 actuate the corresponding drive assemblies 60 to drive the movable platform 40 and the connector 30 to rotate relative to the fixed platform 10 in the axial direction of the yaw shaft 33. For example, when rotation directions of motor 501 and the motor 502 are the same and that speeds of the motor 501 and the motor 502 are different, the motor 501 and the motor 502 separately actuate the drive assembly 601 and the drive assembly 602 to supply different power to the left and right sides of the center axis of the of the movable platform 40, so that the movable platform 40 rotates in the yaw angle (Y1/Y2) direction while rotating in the pitch angle (P1/P2) direction.

Referring to FIG. 4 and FIG. 5, when rotation directions of the motor 501 and the motor 502 are different, if speeds of the motor 501 and the motor 502 are the same, a push force and a pull force which are supplied by the drive assembly 601 and the drive assembly 602 to the left and right sides of the center axis of the movable platform 40 are in a balance, so that the movable platform 40 rotates in the yaw angle (Y1/Y2) direction.

In some embodiments, referring to FIG. 4 and FIG. 5, when rotation directions of the two motors 50 are different and speeds of the two motors 50 are different, the two motors 50 actuate the corresponding drive assemblies 60 to drive the movable platform 40 to rotate relative to the connector 30 in the axial direction of the pitch shaft 34, and the two motors 50 actuate the corresponding drive assemblies 60 to drive the movable platform 40 and the connector 30 to rotate relative to the fixed platform 10 in the axial direction of the yaw shaft 33. For example, when rotation directions of motor 501 and the motor 502 are different and that speeds of the motor 501 and the motor 502 are also different, a push force and a pull force which are supplied by the drive assembly 601 and the drive assembly 602 to the left and right sides of the center axis of the movable platform 40 are not in a balance, so that the movable platform 40 rotates in the pitch angle (P1/P2) direction while rotating in the yaw angle (Y1/Y2) direction.

In this way, the rotations of the movable platform 40 relative to the fixed platform 10 in the two degrees of freedom, namely, the pitch angle (P1/P2) and the yaw angle (Y1/Y2), can be accurately controlled by controlling the rotation directions and speeds of the motor 501 and the motor 502, so that the waist structure 100 can change various actions.

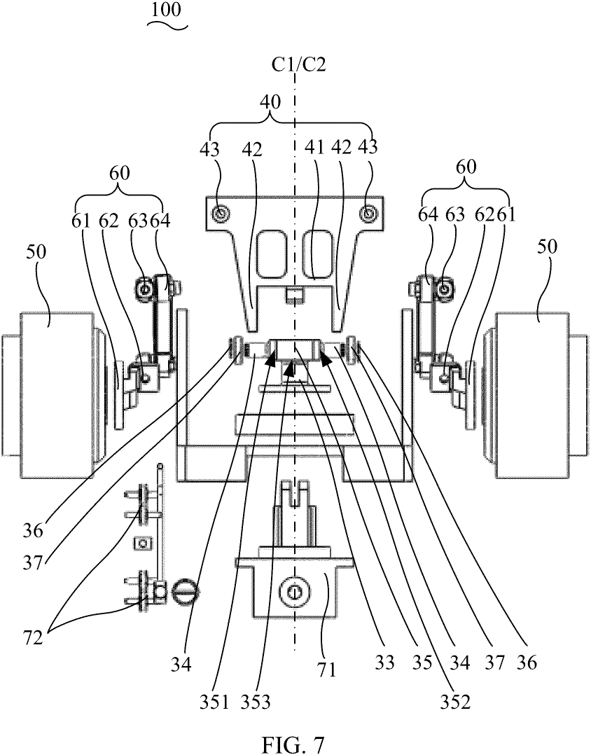

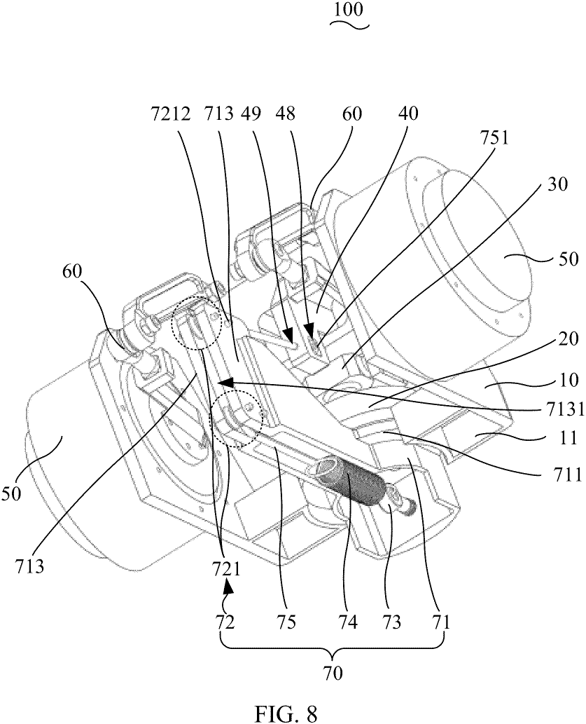

In some embodiments, referring to FIG. 6 and FIG. 7, each drive assembly 60 includes: a moving part 61, a first connecting rod 62, a second connecting rod 63, and a third connecting rod 64. With reference to FIG. 1 and FIG. 4, the motors 50 are connected to the moving parts 61, and can actuate the moving parts 61 to rotate circumferentially. Specifically, output shafts (not shown) of the motors 50 are fixedly connected to the moving parts 61, to drive the moving parts 61 to rotate when the output shafts of the motors rotate. The first connecting rods 62 are connected to the moving parts 61. The second connecting rods 63 are connected to the movable platform 40. The third connecting rods 64 are connected and arranged between the first connecting rod 62 and the second connecting rod 63, and are connected to the first connecting rod 62 and the second connecting rod 63. Referring to FIG. 6, in this way, the drive assembly 60 can change a direction of an actuating force supplied by the motor 50, and provide a push force or a pull force to the movable platform 40 in an axial direction of a roll shaft, so that the gravity of the movable platform 40 and the weight of a load on the movable platform 40 which need to be borne are small; and a relatively good dynamic response performance and carrying capacity are achieved.

In some embodiments, referring to FIG. 6, each drive assembly 60 further includes a first knuckle bearing 65 and a second knuckle bearing 66. The first connecting rod 62 and the third connecting rod 64 are connected through the first knuckle bearing 65 to form a first spherical pair, so that the third connecting rod 64 has a relatively large motion range relative to the first connecting rod 62. The second connecting rod 63 and the third connecting rod 64 are connected through the second knuckle bearing 66 to form a second spherical pair, so that the second connecting rod 63 has a relatively large motion range relative to the third connecting rod 64.

Referring to FIG. 5 and FIG. 6, the motors 50 are fixedly connected to the fixed platform 10. The moving parts 61 can rotate relative to the fixed platform 10. Equivalently, the moving parts 61 are revolute pairs connected to the fixed platform 10. If “S” represents a spherical pair, and “R” represents a revolute pair, the movable platform 40 and the fixed platform 10 are connected through one revolute pair and two spherical pairs, to form an “RSS” type structure. The drive assembly 60 that connects the movable platform 40 to the fixed platform 10 is an “RSS” branched chain. The two drive assemblies 60 are in a parallel relationship, so that the waist structure 100 is constituted into an “RSS” type parallel mechanism. With reference to FIG. 4 to FIG. 6, the first spherical pair and the second spherical pair can provide a relatively large motion range, to support the movable platform 40 to rotate relative to the fixed platform 10 in various postures in the two degrees of freedom, namely, the pitch angle (P1/P2) and the yaw angle (Y1/Y2), so that the waist structure 100 has a relatively large working space.

In some embodiments, referring to FIG. 1 and FIG. 7, the movable platform 40 includes a support 41, two first connecting portions 42, and two second connecting portions 43. The two first connecting portions 42 are symmetric about a center axis of the support 41, and the pitch shaft 34 are connected to the two first connecting portions 42. The two second connecting portions 43 are symmetric about the center axis of the support 41, and the two second connecting portions 43 are respectively connected to the second connecting rods 63 of the two drive assemblies 60. In this way, force bearing point of the movable platform 40 are symmetric, so that it is easy to calculate an actuating force required to be inputted by each motor 50 when the drive assembly 60 drives the movable platform 40 to move, to accurately control the movable platform 40 to move relative to the fixed platform 10.

In some embodiments, referring to FIG. 1, the two second connecting portions 43 are provided with connecting slots 431. The second connecting rods 63 extend into the connecting slots 431 and are connected to the second connecting portions 43. In this way, the second connecting rods 63 and the second connecting portions 43 are combined reliably, and are difficulty separated.

In some embodiments, referring to FIG. 1, the two first connecting portions 42 extend from the support 41. The first connecting portions 42 are provided with first through holes 421. The pitch shaft 34 is connected to the first connecting portions 42 through the first through holes 421. Specifically, the two first connecting portions 42 are extending walls extending from the support 41. A mounting space is formed between the two first connecting portions 42 and the support 41 and is used for accommodating the connector 30. The pitch shaft 34 of the connector 30 penetrates through the two first through holes 421 to cause the movable platform 40 to be connected to the connector 30 and to rotate around the pitch shaft 34.

In some embodiments, referring to FIG. 1 and FIG. 7, in one embodiment, the connector 30 further includes a connecting body 35. There are two pitch shafts 34. The two pitch shafts 34 respectively extend from a first side and a second side of the connecting body 35. The two pitch shafts 34 are integrated with the body. The manufacturing process is simple. The two pitch shafts 34 extending from the first side 351 and the second side 352 of the connecting body 35 respectively penetrate through the two first through holes 421 to be respectively connected to the two first connecting portions 42. In another embodiment, there is one pitch shaft 34. The pitch shaft 34 penetrates through the first side and the second side of the body and penetrates through the two first through holes 421 respectively. In this way, different pitch shafts 34 can be removed from the connecting body 35 for replacement.

In some embodiments, referring to FIG. 7, the connecting body 35 includes a third side 353 located between the first side 351 and the second side 352. The yaw shaft 33 extends from the third side. In this way, the connector 30 is formed into a “T″-shaped structure. With reference to FIG. 1, the axial direction of the yaw shaft 33 is consistent with a yaw axis direction, and the axial direction of the pitch shaft 34 is consistent with a pitch axis direction. By a simple structure, the waist structure 100 has the two degrees of freedom in the pitch angle (P1/P2) direction and the yaw angle (Y1/Y2) direction, so that the manufacturing process can be simplified.

In some embodiments, referring to FIG. 7, limiting portions 36 are arranged at ends of the pitch shafts 34 away from the connecting body 35. The connector 30 further includes connecting bearings 37. The connecting bearings 37 are arranged in the first through holes 421 and sleeve the pitch shafts 34. The limiting portions 36 are used for limiting axial displacements of the connecting bearings 37 along the pitch shafts 34.

In some embodiments, referring to FIG. 1 and FIG. 4, the fixed platform 10 includes a base 11, two mounting portions 12, and a shaft hole 13. The two mounting portions 12 are symmetric about a center axis of the base 11. Mounting holes (which are blocked in the figure, not shown) are formed in the mounting portions 12, and the motors 50 are mounted in the mounting holes. The shaft hole 13 is formed in a center of the base 11, and the load-carrying bearing 20 is arranged in the shaft hole 13.

Specifically, the mounting portions 12 are platy structures symmetric about the center axis of the base 11. In one embodiment, the two mounting portions 12 are fixedly mounted on two sides of the base 11. In another embodiment, the two mounting portions 12 respectively extend from two sides of the base 11. The waist structure 100 of this embodiment of this application can adopt any one of the above embodiments, and will not be limited here.

In some embodiments, referring to FIG. 1 and FIG. 4, the motors 50 are mounted in the mounting holes and are connected to the moving parts 61. The mounting portions 12 are located between the motors 50 and the moving parts 61. If a space encircled by the two mounting portions 12 and the base 11 is an internal space of the fixed platform 10, and spaces outside the two mounting portions 12 opposite to the internal space are external spaces of the fixed platform 10, the two motors 50 are mounted in the external spaces of the fixed platform 10. The two drive assemblies 60, the movable platform 40, the connector 30, and the load-carrying bearing 20 are all arranged in the internal space of the fixed platform 10, so that the internal space of the fixed platform 10 is compact in structure, and it is convenient to connect the motors 50 to an external power supply device or a power line.

Referring to FIG. 4, in one embodiment, the outer ring 22 of the load-carrying bearing 20 is arranged in the shaft hole 13 and is fixedly connected to the shaft hole 13. In another embodiment, the load-carrying bearing 20 is arranged above the shaft hole 13. The outer ring 22 of the load-carrying bearing 20 is fixedly connected to the base 11. The inner ring 21 of the load-carrying bearing 20 corresponds to the shaft hole 13. In this way, the load-carrying bearing 20 and the base 11 can favorably bear the gravity of the movable platform 40 and the weight of the load on the movable platform 40, so that the carrying capacity of the waist structure 100 is improved. The waist structure 100 of this embodiment of this application can adopt any one of the above embodiments, and will not be limited here.

In some embodiments, referring to FIG. 5, the two motors 50 and the two drive assemblies 60 are symmetric about the center axis C2 of the base 11. In some embodiments, the two motors 50, the two drive assemblies 60, and the two second connecting portions 43 of the movable platform 40 are symmetric about the center axis C2 of the base 11. In this way, the structure of the waist structure 100 is in a left and right symmetry arrangement, which can effectively ensure the symmetry of a motion space of the movable platform.

In some embodiments, referring to FIG. 4, FIG. 7, and FIG. 8, the waist structure 100 further includes a pull wire module 70, configured to compensate the gravity of the movable platform 40. The pull wire module 70 includes a follower 71, a pulley assembly 72, a fixed part 73, an elastic part 74, and a pull wire 75. The follower 71 is connected to the inner ring 21 of the load-carrying bearing 20. The pulley assembly 72 and the fixed part 73 are arranged on the follower 71. The elastic part 74 is connected to the fixed part 73. The pull wire 75 cooperates with the pulley assembly 72. One end of the pull wire 75 is connected to the elastic part 74, and the other end of the pull wire 75 is connected to the movable platform 40. In one embodiment, the elastic part 74 can be a tension spring, and the pull wire 75 can be a metal wire.

In a case that the movable platform 40 rotates relative to the fixed platform 10 around the pitch shaft 34, the elastic part 74 is stretched according to a degree of pitching of the movable platform 40, to provide an elastic force to compensate the gravity of the movable platform 40 and the weight of the load on the movable platform 40, that is, to provide gravity compensation to improve the carrying capacity of the waist structure 100. A stress status of the waist structure 100 during movement of the robot 1000 can be effectively improved, and the response speed can be increased. In addition, under the action of the gravity compensation of the pull wire module 70, the waist structure 100 can be stably kept in a certain posture without deformation, to improve the motion accuracy.

In a case that the movable platform 40 rotates relative to the fixed platform 10 in the axial direction of the yaw shaft 33, the follower 71 follows the movable platform 40 to rotate relative to the fixed platform 10 in the axial direction of the yaw shaft 33. In this way, a change in a force direction of a pull force of the pull wire 75 caused by the rotation of the movable platform 40 around the yaw shaft 33 can be avoided, and motion decoupling can be achieved, so that the change of the pull force of the pull wire 75 only depends on a change in an angle of the movable platform 40 around the pitch shaft 34 (an angle change along the pitch angle (P1/P2)).

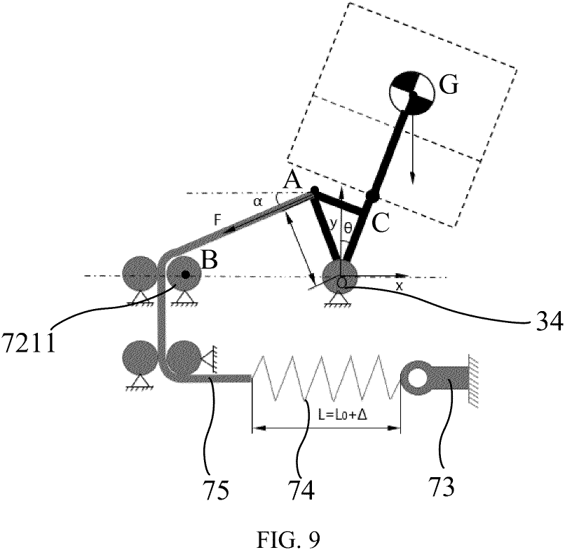

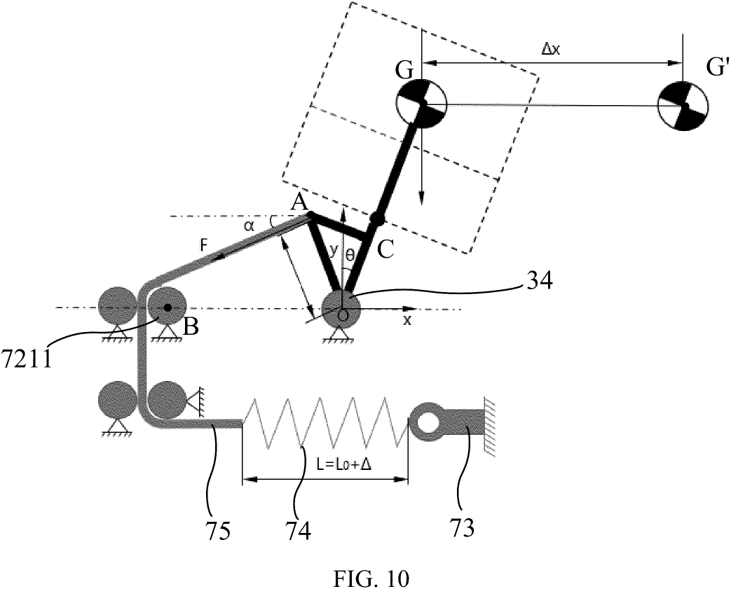

In some embodiments, with reference to FIG. 7, FIG. 8, and FIG. 9, when the elastic part 74 is in a stretched state, the gravity of the movable platform 40 is compensated on the basis of a first distance, a second distance, an elongation of the elastic part 74, a pitch inclination angle, and a pull wire inclination angle. The first distance is a distance between a center-of-gravity position of the movable platform 40 and an axis position of each pitch shaft 34; the second distance is a distance between a center of gravity of a pulley 7211 of the pulley assembly 72 and an axis position of the yaw shaft 33; the pitch inclination angle is an angle that the movable platform 40 rotates around the pitch shaft 34 relative to a center-of-gravity direction; and the pull wire inclination angle is an inclination angle of a portion of the pull wire 75 located between the pulley 7211 and the movable platform 40 relative to a plane where the fixed platform 10 is located.

FIG. 9 is a schematic diagram of an action principle of gravity compensation achieved by the pull wire module 70 in a state that the movable platform 40 rotates around the pitch shaft 34 relative to the fixed platform 10.

Point A is a connecting point between the pull wire 75 and the movable platform 40; point B is the center of gravity and rotation center of the pulley 7211 in the structure of the pulley 7211; point O is the center-of-gravity position of the pitch shaft 34; point G is the center-of-gravity position of the movable platform 40; and point C is a vertical point of a vertical line between point A and line segment OG. Point O may also be a point located at the axis position of the yaw shaft 33. To facilitate the following description, in this embodiment shown in FIG. 9, it is assumed that the pulley 7211 in the pulley assembly 72 has a relatively small radius. A distance between the pull wire 75 on the pulley 7211 and the rotation center of the pulley 7211 is relatively short, that is, a distance between the pull wire 75 on the pulley 7211 and point B is relatively short, so that a distance between point A and point B approximatively represents a length of the pull wire 75 between point A and point B. Or, it is assumed that the pull wire 75 passes through the rotation center B of the pulley 7211. In this way, a distance between point A and point B is a length of the pull wire 75 between point A and point B.

It is set that a length of line segment AC is la, that a distance between point C and point O is lb, that a distance between point B and point O is the second distance 1c, that a distance between point G and point O is the first distance 1h, that a distance between point A and point O is 1s, that a rectangular plane coordinate system is built by taking point O as an origin, that a yaw angle of line segment OG relative to a y axis direction of the coordinate system is the pitch inclination angle θ, and that an included angle between line segment AB and an x axis of the coordinate system is the pull wire inclination angle α. Thus, a rigidity k of the elastic part 74 required for gravity compensation satisfies:

$$\text{k} \text{=} \frac{\text{mglhsin} {}^{\text{θ}}}{\text{lc} \text{Δ} {\text{sin}}^{\text{α}}} ;$$

where Δ is the elongation of the elastic part 74, that is, a stretched length of the elastic part 74; and mg is an equivalent gravity of the center-of-gravity position G of the movable platform 40. In the state that the movable platform 40 rotates around the pitch shaft 34 relative to the fixed platform 10, mg will not change. Therefore, the rigidity of the elastic part 74 is related to the first distance 1h, the second distance 1c, the elongation Δ of the elastic part 74, the pitch inclination angle θ, and the pull wire inclination angle α. The gravity of the movable platform 40 is compensated on the basis of the above parameters.

Specifically, point B and point O are on the same horizontal line. It is assumed that a torque generated by the gravity mg at point O is T1, T1=mglhsinθ. It is assumed that the elastic part 74 is stretched, so that a torque provided by the pull wire module 70 at point A is T2, T2=klcΔsinα. In case of T1=T2, the torque provided by the pull wire module 70 can compensate for the torque generated by the gravity mg, so that if the rigidity k of the elastic part 74 satisfies:

$$\text{k} \text{=} \frac{\text{mglhsin} {}^{\text{θ}}}{\text{lc} \text{Δ} {\text{sin}}^{\text{α}}} ;$$

the pull wire module 70 can realize a gravity compensation function.

Further, after the parts of the waist structure 100 are confirmed, the positions of the pulley 7211 and the connector 30 are fixed, so the second distance 1c will not change. Referring to FIG. 9, sin

$$\text{α=} \frac{{A}_{\text{y}}}{\sqrt{\left({A}_{\text{x}} + 1 \text{c}\right) + {A}_{\text{y}}^{2}}} ,$$

where A_{y} is a coordinate of point A at the y axis,

$${A}_{y} = l s sin \left(arctan \frac{1 b}{1 a} + \frac{π}{2} - θ\right) ;$$

Aₓ is a coordinate of point A at the x axis,

$${A}_{x} = l s cos \left(arctan \frac{1 b}{1 a} + \frac{π}{2} - θ\right) .$$

After the parts of the waist structure 100 are confirmed, the center-of-gravity position G of the movable platform 40 is confirmed; the position of connecting point A between the pull wire 75 and the movable platform 40 is fixed; the center-of-gravity position O of the pitch shaft 34 is fixed; and the position of point C is also fixed. Therefore, the distance 1h between point G and point O, the distance 1s between point A and point O, the distance 1b between point C and point O, and the distance 1a between point A and point C will not change. Therefore, a size of the rigidity k of the elastic part 74 required for gravity compensation only depends on the pitch inclination angle θ and the elongation Δ of the elastic part 74. In a case that the pitch inclination angle θ=90°, the elongation Δ of the elastic part 74 is the maximum, and the rigidity k of the elastic part 74 required for gravity compensation is the maximum; and the pull wire module 70 can completely compensate for the gravity mg. In this way, the rigidity k of the elastic part 74 corresponding to the pitch inclination angle θ=90° is used as a rigidity baseline of the elastic part 74, to meet a gravity compensation requirement for the movable platform 40.

In some embodiments, with reference with FIG. 10, when the elastic part 74 is in the stretched state, after the center-of-gravity position of the movable platform 40 skews, the gravity of the movable platform is compensated on the basis of a third distance, the first distance, the second distance, the elongation of the elastic part 74, the pitch inclination angle, and the pull wire inclination angle; and the third distance is a distance between the center-of-gravity position of the movable platform before skewing and the center-of-gravity position of the movable platform after skewing. After the center-of-gravity position of the movable platform 40 skews relative to the initial position, namely, point G, (the center-of-gravity position of the movable platform 40 before skewing) due to a motion or a change in the load, the center-of-gravity position of the movable platform 40 after skewing is set to be G′, so that a distance between point G and G′ is Δx (which is the third distance). In this case, the torque T1 generated by the gravity mg at point O is T1′, T1′=mg(lhsinθ+Δx), T1′>T1. In this case, the motor 50 provides a torque T3, T3=mgΔx, and the pull wire module 70 provides a torque T2, T2=klcΔsinα=mglhsinθ. The gravity compensation is achieved by combining the torque T2 and the torque T3, T2+T3=T1′. That is, in this case, the structure of the pull wire 75 can still provide part of the gravity compensation, to improve the stress status of the waist structure 100 and improve the motion response speed and the motion accuracy.

In some embodiments, referring to FIG. 8, a receiving space 48 and a pull wire hole 49 are formed in the movable platform 40. The pull wire 75 includes a pull wire head 751. The pull wire head 751 is received in the receiving space 48, and the pull wire 75 is led out from the pull wire hole 49. In this way, the receiving space 48 can play a role of protecting the pull wire head 751.

In some embodiments, referring to FIG. 4 and FIG. 8, the follower 71 includes a following portion 711, a fixing portion 712, and an extending portion 713. The following portion 711 is connected to the inner ring 21 of the load-carrying bearing 20. Specifically, the connector 30 and the following portion 711 are respectively connected to two sides, facing away from each other, of the inner ring 21 of the load-carrying bearing 20. A fixing hole 7121 is formed in the fixing portion 712, and the fixed part 73 is mounted in the fixing hole 7121. The pulley assembly 72 is arranged at the extending portion 713.

In some embodiments, referring to FIG. 4, the follower 71 includes two extending portions 713 spaced from each other; a pulley slot 7131 is formed between the two extending portions 713; and each extending portion 713 is provided with a pin hole 7132. The pulley assembly 72 includes two pulley systems 721, and the two pulley systems 721 are arranged at the extending portions 713 in a spaced manner. With reference to FIG. 9, the pulley systems 721 include pulleys 7211, spacers (not shown), and pins 7212. The pulleys 7211 are arranged between the two extending portions 713. The pins 7212 penetrate through the pin holes 7132 and the pulleys 7211. The spacers are arranged between the pulleys 7211 and the extending portions 713. Referring to FIG. 9, the center-of-gravity position of the pulley 7211 of the topmost pulley system 721 of the two pulley systems 721 corresponds to point B in FIG. 9, and the center-of-gravity position of the pulley 7211 and the center-of-gravity position of the pitch shaft 34 are on the same horizontal line.

The embodiments of this application may be formed by using any combination of all the foregoing technical solutions, and details are not described here.

Referring to FIG. 2, the embodiments of this application provide a robot 1000. The robot 1000 includes the waist structure 100 according to any one of the above implementations, a body structure 300, and a lower limb structure 400. The body structure 300 is connected to the movable platform 40. The lower limb structure 400 is connected to the fixed platform 10. By using the waist structure 100 in the parallel “RSS” form to connect the body structure 300 to the lower limb structure 400, the robot 1000 provided by this embodiment of this application can achieve motions of an upper limb structure 200 relative to the lower limb structure 400 in two degrees of freedom, namely, in a pitch angle (P1/P2) direction and a yaw angle (Y1/Y2) direction, so that the robot 1000 has relatively high load-carrying capacity and relatively good drive capacity.

In the foregoing embodiments, description of each embodiment focuses on a different part, and for parts that are not described in detail in one embodiment, refer to the related description of other embodiments.

In the descriptions of the embodiments of this application, specific features, structures, materials, or characteristics may be combined in a proper manner in any one or more of the embodiments or examples.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A waist structure of a robot, comprising:
a fixed platform;
a load-carrying bearing arranged on the fixed platform;
a connector comprising a first end and a second end facing away from each other, the first end being provided with a yaw shaft, the yaw shaft being connected to the load-carrying bearing, and the second end being provided with a pitch shaft;
a movable platform rotatably connected to the pitch shaft;
one or more motors arranged on the fixed platform; and
one or more drive assemblies, each drive assembly being connected to the movable platform and a corresponding motor;
wherein the motors are configured to actuate the drive assemblies to drive the movable platform to, independently, rotate relative to the connector in an axial direction of the pitch shaft and rotate relative to the fixed platform in an axial direction of the yaw shaft.

2. The waist structure of the robot according to claim 1, wherein the one or more motors are two motors that respectively and independently actuate two corresponding drive assemblies to move;
the two motors are configured to actuate the corresponding drive assemblies to drive the movable platform to rotate relative to the connector in the axial direction of the pitch shaft by synchronously rotating in a same direction; and
the two motors are configured to actuate the corresponding drive assemblies to drive the movable platform and the connector to rotate relative to the fixed platform in the axial direction of the yaw shaft by having different rotation directions.

3. The waist structure of the robot according to claim 2, wherein the two motors are configured to actuate the corresponding drive assemblies to drive the movable platform to rotate relative to the connector in the axial direction of the pitch shaft and actuate the corresponding drive assemblies to drive the movable platform and the connector to rotate relative to the fixed platform in the axial direction of the yaw shaft by having different rotation speeds.

4. The waist structure of the robot according to claim 2, wherein the two motors are configured to actuate the corresponding drive assemblies to drive the movable platform to rotate relative to the connector in the axial direction of the pitch shaft and actuate the corresponding drive assemblies to drive the movable platform and the connector to rotate relative to the fixed platform in the axial direction of the yaw shaft by having a same rotation direction and different rotation speeds.

5. The waist structure of the robot according to claim 2, wherein the two motors are configured to actuate the corresponding drive assemblies to drive the movable platform to rotate relative to the connector in the axial direction of the pitch shaft and actuate the corresponding drive assemblies to drive the movable platform and the connector to rotate relative to the fixed platform in the axial direction of the yaw shaft by having different rotation directions and different rotation speeds.

6. The waist structure of the robot according to claim 1, wherein each drive assembly comprises:
a moving part connected to the corresponding motor to form a revolute pair;
a first connecting rod connected to the moving part;
a second connecting rod connected to the movable platform; and
a third connecting rod connected and arranged between the first connecting rod and the second connecting rod and is connected to the first connecting rod and the second connecting rod.

7. The waist structure of the robot according to claim 6, wherein each drive assembly further comprises a first knuckle bearing and a second knuckle bearing; the first connecting rod and the third connecting rod are connected through the first knuckle bearing to form a first spherical pair; and the second connecting rod and the third connecting rod are connected through the second knuckle bearing to form a second spherical pair.

8. The waist structure of the robot according to claim 1, wherein the fixed platform comprises:
a base;
two mounting portions, the two mounting portions being symmetric about a center axis of the base, mounting holes being formed in the mounting portions, and the motors being mounted in the mounting holes; and
a shaft hole formed in a center of the base, the load-carrying bearing being arranged in the shaft hole.

9. The waist structure of the robot according to claim 1, wherein the waist structure further comprises a pull wire module, configured to compensate the gravity of the movable platform in response to a movement of the movable platform relative to the fixed platform.

10. The waist structure of the robot according to claim 9, wherein the pull wire module comprises:
a follower connected to the fixed platform;
a pulley assembly arranged on the follower;
a fixed part arranged on the follower;
an elastic part fixedly connected to the fixed part; and
a pull wire cooperating with the pulley assembly, one end of the pull wire being connected to the elastic part, and the other end of the pull wire being connected to the movable platform.

11. The waist structure of the robot according to claim 10, wherein the follower is configured to rotate around the yaw shaft relative to the fixed platform when the movable platform rotates around the yaw shaft relative to the fixed platform.

12. The waist structure of the robot according to claim 10, wherein a receiving space and a pull wire hole are formed in the movable platform; the pull wire comprises a pull wire head; the pull wire head is received in the receiving space; and the pull wire is led out from the pull wire hole.

13. The waist structure of the robot according to claim 10, wherein the follower comprises:
a following portion connected to the inner ring of the load-carrying bearing;
a fixing portion provided with a fixing hole, the fixed part being mounted in the fixing hole; and
an extending portion, the pulley assembly being arranged at the extending portion.

14. A robot, comprising:
the waist structure according to claim 1;
a body structure connected to the movable platform of the waist structure; and
a lower limb structure connected to the fixed platform of the waist structure.
